(19) United States
(12) Patent Application Publication
(10) Pub. No.: US 2017/0351739 A1
(43) Pub. Date: Dec. 7, 2017

(54) METHOD AND APPARATUS FOR IDENTIFYING TIMELINESS-ORIENTED DEMANDS, AN APPARATUS AND NON-VOLATILE COMPUTER STORAGE MEDIUM

(71) Applicant: BAIDU ONLINE NETWORK TECHNOLOGY (BEIJING) CO., LTD., Beijing (CN)

(72) Inventors: Hongjian ZOU, Beijing (CN); Gaolin FANG, Beijing (CN); Jun CHENG, Beijing (CN)

(73) Assignee: Baidu Online Network Technology (Beijing) Co., Ltd., Beijing (CN)

(21) Appl. No.: 15/536,497

(22) PCT Filed: Nov. 13, 2015
(86) PCT No.: PCT/CN2015/094526

§ 371 Date: Jun. 15, 2017

(30) Foreign Application Priority Data
Jul. 23, 2015 (CN) 201510436121.5

(51) Int. Cl. G06F 17/30; G06F 7/08

(52) U.S. Cl. CPC G06F 17/30528; G06F 7/08; G06F 17/30463

(57) ABSTRACT

The present disclosure provides a method and apparatus for identifying timeliness-oriented demands, an apparatus and a non-volatile computer storage medium. The method comprises: receiving a query input by the user; identifying whether the query has timeliness-oriented demands based on expression characteristics which are pre-extracted from a timeliness-oriented event reported by a timeliness-oriented site and are capable of reflecting timeliness-oriented demands. The present disclosure sufficiently uses the priori knowledge for timeliness-oriented demands identification, does not rely on the posteriori knowledge such as the user's searching behavior data using the query, facilitates identifying the timeliness-oriented demands in a more timely manner, and improves the efficiency of identifying the timeliness-oriented demands.

The present disclosure claims priority to the Chinese patent application No. 201510436121.5 entitled “Method and Apparatus for Identifying Timeliness-oriented Demands” filed on the filing date Jul. 23, 2015, the entire disclosure of which is hereby incorporated by reference in its entirety.

### FIELD OF THE DISCLOSURE

The present disclosure relates to the technical field of the Internet technologies, and particularly to a method and apparatus for identifying timeliness-oriented demands, an apparatus and a non-volatile computer storage medium.

### BACKGROUND OF THE DISCLOSURE

When a user searches for a recent event or popular character, he not only expects search results to be related to the event or popular character, but also expects the search results to be recent or the latest, i.e., he has certain demands for timeliness of the search results. The user's demands for timeliness of the search results are called timeliness-oriented demands.

In a method of identifying timeliness-oriented demands, a search frequency for a query having timeliness-oriented demands increases suddenly at a certain time point or increases constantly in a certain time period. Based on this characteristic, the user's query is mined to obtain the query having the timeliness-oriented demands and thereby identify the timeliness-oriented demands. However, this method depends on the user's search behavior data to a great degree, i.e., identifies the timeliness-oriented demands through change features of the search frequency according to the query. This method belongs to an identifying method based on a posteriori knowledge with a lower identifying efficiency.

### SUMMARY OF THE DISCLOSURE

A plurality of aspects of the present disclosure provide a method and apparatus for identifying timeliness-oriented demands, an apparatus and a non-volatile computer storage medium, to improve the efficiency of identifying timeliness-oriented demands.

According to an aspect of the present disclosure, there is provided a method for identifying timeliness-oriented demands, comprising:

receiving a query input by the user;

identifying whether the query has timeliness-oriented demands based on expression characteristics which are pre-extracted from a timeliness-oriented event reported by a timeliness-oriented site and are capable of reflecting timeliness-oriented demands.

According to another aspect of the present disclosure, there is provided an apparatus for identifying timeliness-oriented demands, comprising:

a receiving module configured to receive a query input by the user;

an identifying module configured to identify whether the query has timeliness-oriented demands based on expression characteristics which are pre-extracted from a timeliness-oriented event reported by a timeliness-oriented site and are capable of reflecting timeliness-oriented demands.

According to a further aspect of the present disclosure, there is provided an apparatus, comprising

one or more processors;

a memory;

one or more programs stored in the memory and configured to execute the following operations when executed by the one or more processors:

receiving a query input by the user;

identifying whether the query has timeliness-oriented demands based on expression characteristics which are pre-extracted from a timeliness-oriented event reported by a timeliness-oriented site and are capable of reflecting timeliness-oriented demands.

According to a further aspect of the present disclosure, there is provided a non-volatile computer storage medium in which one or more programs are stored, an apparatus being enabled to perform the following operations when said one or more programs are executed by the apparatus:

receiving a query input by the user;

identifying whether the query has timeliness-oriented demands based on expression characteristics which are pre-extracted from a timeliness-oriented event reported by a timeliness-oriented site and are capable of reflecting timeliness-oriented demands.

In the present disclosure, expression characteristics capable of reflecting timeliness-oriented demands are pre-extracted from the timeliness-oriented event reported by the timeliness-oriented site, and whether the user-input query has timeliness-oriented demands is judged based on the pre-extracted expression characteristics capable of reflecting timeliness-oriented demands. The expression characteristics which are pre-extracted from the timeliness-oriented event reported by the timeliness-oriented site and are capable of reflecting timeliness-oriented demands belong to priori knowledge. The present disclosure sufficiently uses the priori knowledge for timeliness-oriented demands identification, does not rely on the posteriori knowledge such as the user's searching behavior data using the query, facilitates identifying the timeliness-oriented demands in a more timely manner, and improves the efficiency of identifying the timeliness-oriented demands.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making any inventive efforts.

FIG. 1 is a flow chart of a method of identifying timeliness-oriented demands according to an embodiment of the present disclosure;

FIG. 2 is a flow chart of a method of extracting expression characteristics from a timeliness-oriented event reported at a timeliness-oriented site according to an embodiment of the present disclosure;

FIG. 3 is a flow chart of an implementation mode of step 201 according to an embodiment of the present disclosure;

FIG. 4 is a block diagram of an apparatus for identifying timeliness-oriented demands according to an embodiment of the present disclosure;

FIG. 5 is a block diagram of an apparatus for identifying timeliness-oriented demands according to another embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

By analyzing the reporting procedure of timeliness-oriented events such as a sudden event/hot character/hot topic and the user's search behaviors, the Inventor finds that after the sudden event/hot character/hot topic occurs in the real world, first the earliest report will appear on some sites, for example news reports, then some users search using the query in different forms, then some more thorough and in-depth or simply-transferred reports will appear, and a different number of users continue to search according to different degrees of hotness of the timeliness-oriented event. After the sudden event/hot character/hot topic lasts a time period, the user's concerns for it gradually reduce, and the number of reports and number of searches also fall. As can be seen from the above, after a timeliness-orientated event happens, reports will first be presented through some sites, for example news media, and then the user's search behaviors appear. A query result that can satisfy the user's timeliness-oriented demands is obtained certainly after the corresponding timeliness-oriented event happens and recorded. For ease of description, those sites capable of reporting the timeliness-oriented event in time before the user's search behaviors are called timeliness-oriented sites, for example, the timeliness-oriented sites may be news sites or some blogs, forums or the like capable of transferring new events or hot topics in time.

According to the above features, the present disclosure provides a scheme of identifying timeliness-oriented demands with the following main principles: pre-extracting expression characteristics capable of reflecting timeliness-oriented demands from the timeliness-oriented event reported by the timeliness-oriented site, so that upon inputting the query for search, the user may judge whether the user's query has timeliness-oriented demands based on the pre-extracted expression characteristics capable of reflecting timeliness-oriented demands, to improve the efficiency of identifying the timeliness-oriented demands.

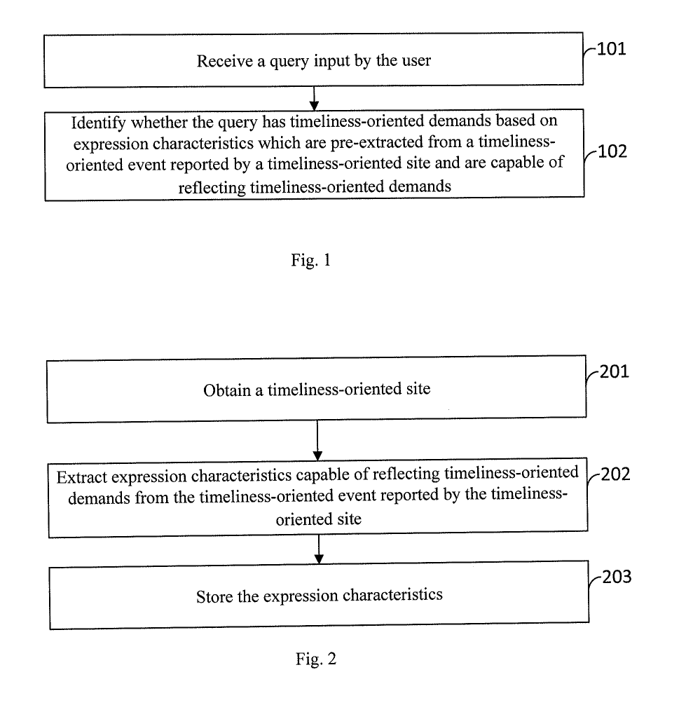

FIG. 1 is a flow chart of a method of identifying timeliness-oriented demands according to an embodiment of the present disclosure. As shown in FIG. 1, the method comprises:

101: receiving a query input by the user.

102: judging whether the user's query has timeliness-oriented demands based on expression characteristics which are pre-extracted from the timeliness-oriented event reported by the timeliness-oriented site and are capable of reflecting timeliness-oriented demands.

In the present embodiment, upon inputting the query for search, the user performs timeliness-oriented demands identification for the user-input query based on expression characteristics which are pre-extracted from the timeliness-oriented event reported by the timeliness-oriented site and are capable of reflecting timeliness-oriented demands. The expression characteristics which are pre-extracted from the timeliness-oriented event reported by the timeliness-oriented site and are capable of reflecting timeliness-oriented demands belong to priori knowledge. The present embodiment sufficiently uses the priori knowledge for timeliness-oriented demands identification, does not rely on the posteriori knowledge such as the user's searching behavior data using the query, facilitates identifying the timeliness-oriented demands in a more timely manner, and improves the efficiency of identifying the timeliness-oriented demands.

The method according to the present embodiment assists in satisfying the user's searching demands by performing timeliness-oriented identification for the user-input query. Once the user's query is identified as having the timeliness-oriented demands, it is feasible to recommend search results related to the query and satisfying the timeliness-oriented demands to the user, so that the user quickly obtains desired information from the search results and the user's satisfaction for the search results is improved.

Before implementing the method of identifying the timeliness-oriented demands according to the present embodiment, it is necessary to pre-extract expression characteristics capable of reflecting timeliness-oriented demands from the timeliness-oriented event reported by the timeliness-oriented site. FIG. 2 shows an implementation mode of extracting expression characteristics from the timeliness-oriented event reported by the timeliness-oriented site, comprising:

201: obtaining a timeliness-oriented site.

202: extracting expression characteristics capable of reflecting timeliness-oriented demands from the timeliness-oriented event reported by the timeliness-oriented site.

203: storing the expression characteristics.

In step 203, the storage forms of the expression characteristics are not limited, for example, the expression characteristics may be stored in a features dictionary, a database, an information listing or the like.

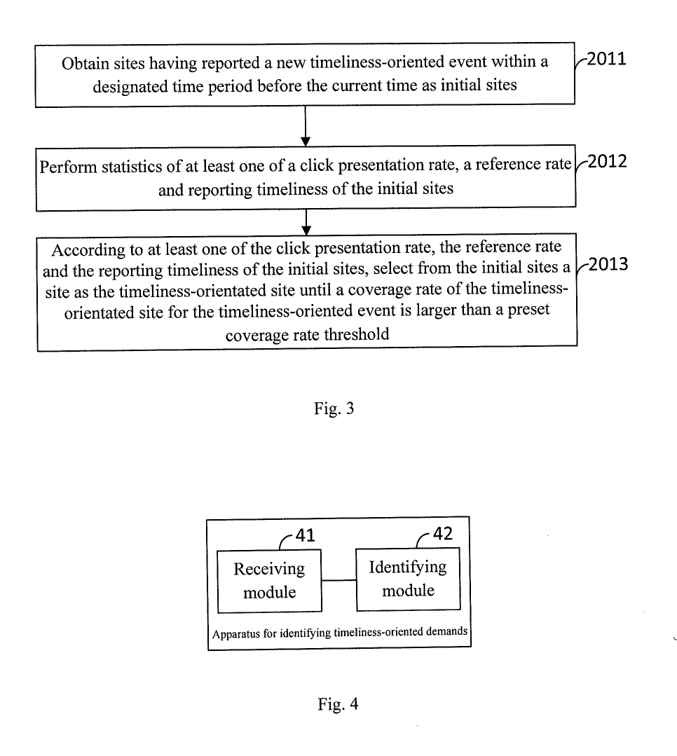

An implementation mode of the step 201, namely, obtaining a timeliness-oriented site, comprises as shown in FIG. 3:

2011: obtaining sites having reported a new timeliness-oriented event within a designated time period before the current time as initial sites.

2012: performing statistics of at least one of a click presentation rate, a reference rate and reporting timeliness of the initial sites.

2013: according to at least one of the click presentation rate, the reference rate and the reporting timeliness of the initial sites, selecting from the initial sites a site as the timeliness-orientated site until a coverage rate of the timeliness-orientated site for the timeliness-oriented event is larger than a preset coverage rate threshold.

In the above step 2011, the designated time period in the designated time period before the current time may be half a year, one month or two weeks, and the designated time period before the current time may be half a year before the current time, a month before the current time or two weeks before the current time, or the like. That is to say, before the timeliness-oriented site is obtained, sites having reported a new timeliness-oriented event within half a year, one month or two weeks before the current time are first obtained as the initial sites.

Optionally, after the initial sites are obtained, low-quality sites may be removed from the initial sites. The low-quality sites refer to sites whose quality is lower than a quality threshold, for example, known cheating sites or commodity sites. Filtering the initial sites may reduce adverse influence caused by the low-quality sites and help improve the precision of the expression characteristics extracted subsequently.

In the above step 2012, the click presentation rate of the initial site may be obtained from the click presentation rate of the timeliness-oriented event reported by the initial site. The click presentation rate of the timeliness-oriented event reported by the initial site refers to a result obtained by weighting and averaging click times and presentation times of the timeliness-oriented event reported by the initial site.

The reference rate of the initial site may be obtained from a reference rate of the timeliness-oriented event reported by the initial site. The reference rate of the timeliness-oriented event reported by the initial site refers to a ratio of times of the timeliness-oriented event on the initial site being cited or transferred by other sites to total times of the timeliness-oriented event being cited or transferred by other sites.

The reporting timeliness of the initial site may be reflected by an average time interval between time when the initial site reports the timeliness-oriented event and time of occurrence of the timeliness-oriented event. The shorter the average time interval is, the more timely the event is reported, and the stronger the timeliness of the site is; the longer the average time interval is, the less timely the event is reported, and the less the timeliness of the site is. For example, the average time interval between time when the initial site reports the timeliness-oriented event and time of occurrence of the timeliness-oriented event may be obtained in the following manner: selecting several historical timeliness-oriented events, performing statistics of the time interval between time when the initial site reports each historical timeliness-oriented event and time of occurrence of each historical timeliness-oriented event, and obtaining an average value from the several time intervals.

It is appreciated that the timeliness-oriented site may be measured by any standard of the click presentation rate, the reference rate and the reporting timeliness, may also be measured by any two standards, and most preferably measured by three standards.

In the above step 2013, if the number of timeliness-oriented sites is too small, coverage of the timeliness-oriented event is insufficient; if the number of timeliness-oriented sites is too large, the coverage of the timeliness-oriented event will be improved, but mis-recall increases. Therefore, a coverage rate range is set in the present embodiment. It can be ensured that the timeliness-oriented sites selected based on the coverage rate range are not too many and not too few so that high accuracy and a high recall rate can be achieved simultaneously. In addition, a selection threshold is preset, and the selection threshold corresponds to at least one of the click presentation rate, the reference rate and the reporting timeliness. The above step 2013 is specifically as follows:

According to at least one of the click presentation rate, the reference rate and the reporting timeliness of the initial sites, selecting from the initial sites a site in which at least one of the click presentation rate, the reference rate and the reporting timeliness satisfies the selection threshold as the timeliness-oriented site; calculating the coverage rate of the timeliness-oriented site for the timeliness-oriented event, and ending the operation if the calculated coverage rate is within the preset coverage rate range; if the coverage rate is not within the coverage rate range, adjusting the above selection threshold, and continuing to, according to at least one of the click presentation rate, the reference rate and the reporting timeliness of the initial sites, select from the initial sites a site in which at least one of the click presentation rate, the reference rate and the reporting timeliness satisfies the adjusted selection threshold as the timeliness-oriented site, until the coverage rate of the timeliness-oriented site for the timeliness-oriented event is within the preset coverage rate range.

Illustration is presented below for the correspondence relationship between the selection threshold and the above standard for selecting the timeliness-oriented site basis. For example, if the standard of selecting the timeliness-oriented site basis is the click presentation rate, the selection threshold is a threshold corresponding to the click presentation rate, for example, the initial site whose click presentation rate is larger than the threshold may be selected as the timeliness-oriented site; if the standard of selecting the timeliness-oriented site basis is the reference rate, the selection threshold is a threshold corresponding to the reference rate, for example, the initial site whose reference rate is larger than the threshold may be selected as the timeliness-oriented site; if the standard of selecting the timeliness-oriented site basis is the click presentation rate, the reference rate and the reporting timeliness, the selection threshold may include the threshold corresponding to the click presentation rate, the threshold corresponding to the reference rate and the threshold corresponding to the reporting timeliness, the initial site whose click presentation rate, reference rate and reporting timeliness are respectively larger than corresponding thresholds may be selected as the timeliness-oriented site; or, the selection threshold may also be a weighted average threshold corresponding to the click presentation rate, reference rate and reporting timeliness, then the click presentation rate, the reference rate and the reporting timeliness may be weighted and averaged, and the initial site whose weighted and averaged result is larger than the threshold is selected as the timeliness-oriented site.

The coverage rate of the timeliness-oriented site for the timeliness-oriented event may be obtained in the following manner:

selecting a past time period which is briefly called a historical time period, determining timeliness-oriented events happening in the historical time period, performing, with respect to these timeliness-oriented events, statistics of the number of timeliness-oriented events reported by all timeliness-oriented sites, comparing the number with the total number of timeliness-oriented events happening in this historical time period, and considering the result as the coverage rate of the timeliness-oriented site for the timeliness-oriented events.

Angles and focuses of different sites reporting the same timeliness-oriented event are different. Even though the event is reported at the same angle, forms of expressions might vary. For example, regarding Huang Xiaoming and AngelaBaby's registration for marriage on May 27, 2015, relevant reports have the following titles: “Huang Xiaoming and Angelababy collected marriage certificate on the 27^{th} day”, “Huang Xiaoming and Angelababy got marriage certificate”, “Huang Xiaoming posted marriage certificate and will hold a wedding ceremony in October”, “Huang Xiaoming and Baby got marriage certification in Qingdao”, “Huang Xiaoming and Baby got marriage certificate! Lord Huang embraces a fair lady as wife”, and “Huang Xiaoming and Baby collected marriage certificate and got married”.

These reports are in different expression forms, but they all include words such as “Huang Xiaoming”, “Baby/Angela Baby”, and “got marriage certificate/marriage certificate/registered for marriage/got married”. These words and their combination forms express core content of the timeliness-oriented event/popular characters. Among these words and their combination forms, some words may be extracted from titles of reports on the timeliness-oriented event, and called title features, and some words may be obtained by performing timeliness-oriented demands mining for an event cluster formed by the timeliness-oriented events and called event cluster features. The event cluster features generally include core words capable of reflecting the timeliness-oriented event and co-occurring words of the core words. For example, in the above example, “Huang Xiaoming”, “Baby/Angelababy”, “get married/get marriage certificate” and the like belong to core words; “Qingdao”, “Civil Affairs Bureau”, “the 27^{th} day” and the like belong to co-occurring words in the event cluster “Huang Xiaoming and Baby got marred”.

Either the title features or event cluster features may be used to identify whether the user's query has timeliness-oriented demands, so they are collectively called expression characteristics capable of reflecting the timeliness-oriented demands. That is to say, the expression characteristics of the timeliness-oriented demands refer to expression forms charactering timeliness-oriented demands at the current time or within a specific time range, and their language forms include sentence, phrase, n-gram, word co-occurrence pair and the like.

Based on the above analysis, an implementation mode of the above step 202 specifically comprises:

extracting, from the title of the timeliness-oriented event, title characteristics capable of reflecting timeliness-oriented demands;

performing timeliness-oriented demand mining for the event cluster formed by the timeliness-oriented event to obtain event cluster characteristics capable of reflecting the timeliness-oriented demands.

Furthermore, the implementation mode of extracting, from the title of the timeliness-oriented event, title characteristics capable of reflecting timeliness-oriented demands comprise:

considering a title of each timelines-oriented event as input;

setting an initial weight of the title;

performing processing such as segmenting the title into words, marking part of speech of the words, identifying entity types and removing stop words therefrom, to obtain the title characteristics;

performing statistics of frequency of segmented words in the title characteristics;

if the frequency of segmented words belonging to a preset word class and a preset entity class in the title characteristic is lower than a certain threshold, adjusting the weight of the title characteristic lower, and keeping the weights of remaining title characteristics unchanged;

obtaining the title characteristics and the weights of the title characteristics through the above processing;

storing the above title characteristics and the weights of the title characteristics.

Furthermore, the implementation mode of performing timeliness-oriented demand mining for the event cluster formed by the timeliness-oriented event to obtain event cluster characteristics capable of reflecting the timeliness-oriented demands comprises:

performing word segmentation for the timeliness-oriented event to obtain segmented words in the timeliness-oriented event;

clustering the timeliness-oriented event according to the segmented words in the timeliness-oriented event to obtain at least one event cluster;

as for each event cluster in at least one event cluster, performing statistics of a frequency of segmented words and a file frequency in the event cluster;

according to the frequency of segmented words and the file frequency in the event cluster, selecting, from the segmented words in the event cluster, core words and co-occurring words of core words in the event cluster to constitute the event cluster characteristics corresponding to the event cluster.

In the above implementation mode, clustering the timeliness-oriented event may employ the following manner:

clustering the timeliness-oriented event by using a method such as KNN clustering or hierarchical clustering; or performing statistics of the frequency of high-frequency segmented words and file frequency in the timeliness-oriented event, filtering stop words, then selecting a segmented word whose frequency and file frequency is larger than a certain threshold as a seed word of the cluster, and clustering timeliness-oriented events including the same seed word into one class, namely, an event cluster.

It needs to be appreciated that in the implementation mode, in addition to output of the core words and the co-occurrence words, weights of the core words and the co-occurring words may also be output for subsequent use during the identification of timeliness-oriented demands. The present embodiment does not limit the implementation mode of the weights, for example, the frequency of the segmented words (including core words and co-occurring words), the file frequency, or a combination of the frequency and the file frequency may be considered as the weights of the segmented words, or weighting processing may be performed for the frequency and/or file frequency to obtain the weights of the segmented words, or the weights of the core words or co-occurring words may be manually set. It is appreciated that the weights of the core words theoretically are larger than the weights of the co-occurring words.

In addition to the above mode, a co-occurrence pair in the event cluster characteristics may be obtained by using the idea of co-occurrence pair mining. The idea is specifically implemented as follows:

performing word segmentation for the timeliness-oriented event to obtain segmented words in the timeliness-oriented event;

with a single sentence as a unit, calculating an importance degree of segmented words included in each sentence;

performing statistics of a frequency of the co-occurrence pair of the segmented words and the file frequency (namely, the number of distributed files DF), and calculating pointwise mutual information (PMI) of the co-occurrence pair;

as for each co-occurrence pair, accumulating the importance degree of words included by the co-occurrence pair in the single sentence as the importance degree of the co-occurrence pair in this sentence, and considering a maximum value of the importance degree of the co-occurrence pair in all sentences as the importance degree of the co-occurrence pair;

filtering co-occurrence pairs whose frequency, file frequency, pointwise mutual information and importance degree are lower than a certain threshold;

in conjunction with the frequency, file frequency and pointwise mutual information, adjusting the importance degree of the co-occurrence pair as a final weight of the co-occurrence pair, and outputting the co-occurrence pair and the weight thereof.

In addition, the co-occurrence pair in the event cluster characteristics may be obtained by using a template mining-based idea. The idea is specifically implemented as follows:

A template representing a timeliness-oriented event is obtained by manual summarization or in an automatic manner from a news document expressing timeliness-oriented information or a known query set having timeliness-oriented demands, for example, “**happens **”, “** earthquake” or “**event”. The timeliness-oriented events reported by the timeliness-oriented site are matched based on these templates to obtain words expressing the timeliness-oriented event/hot topic, and screening is performed according to the frequency and the file document to obtain the core words and co-occurring words.

Furthermore, it is feasible to, after obtaining the expression characteristics, e.g., after obtaining the expression characteristics using the above various implementation modes, filter the expression characteristics to remove expression characteristics incapable of reflecting the timeliness-oriented demands among the expression characteristics.

In an implementation mode, a non-timeliness-oriented dictionary is preset. The non-timeliness-oriented dictionary stores some words incapable of reflecting the timeliness-oriented words. Based on this, it is feasible to rely on the preset non-timeliness-oriented dictionary to identify expression characteristics incapable of reflecting the timeliness-oriented demands among the expression characteristics, to remove expression characteristics incapable of reflecting the timeliness-oriented demands among the expression characteristics.

In another implementation mode, it is feasible to rely on a historical event without timeliness-oriented demands to identify expression characteristics incapable of reflecting the timeliness-oriented demands among the expression characteristics, to remove expression characteristics incapable of reflecting the timeliness-oriented demands among the expression characteristics. The procedure of identifying expression characteristics incapable of reflecting the timeliness-oriented demands based on the historical event without timeliness-oriented demands may be: performing statistics of the number of matched results of the expression characteristics in the historical event and in the above timeliness-oriented event and calculating an entropy value; if the entropy value is larger than a certain threshold, this indicates that the expression characteristic cannot well distinguish the historical event without timeliness-oriented event from the timeliness-oriented event, and indicates that it has a poor capability of reflecting the timeliness-oriented demands. Hence, it is considered as the expression characteristics incapable of reflecting the timeliness-oriented demands and needs to be filtered away.

Furthermore, to enrich the extracted expression characteristics to improve the accuracy in identifying the timeliness-oriented demands, in the method it is further feasible to supplement the above expression characteristics according to the user's historical search behavior data. For example, it is feasible to combine the user's historical search behavior data with the timeliness-oriented event reported by the timeliness-oriented site to obtain input data to extract richer expression characteristics therefrom. Or, it is also feasible to extract the expression characteristic only according to the user's historical search behavior data, and add the extracted expression characteristics into the expression characteristics extracted based on the timeliness-oriented event reported by the timeliness-oriented site, thereby forming richer expression characteristic. The user's historical search behavior data here refer to the user's behavior data of using the query to search during the historical search, and mainly refers to frequency change information that the searching frequency of the query suddenly increases at a certain time point or increases constantly in a certain time period.

As known from the above implementation modes of extracting the expression characteristics, the expression characteristics may include title characteristics extracted from the timeliness-oriented event and event cluster characteristics extracted from the event cluster formed by the timeliness-oriented event. Based on this, a specific implementation mode of step 102 includes:

judging whether the query belongs to the title characteristics or event cluster characteristics;

if the judgment result shows that the query belongs to the title characteristics or event cluster characteristics, determining that the query has timeliness-oriented demands;

if the judgment result shows that the query does not belong to the title characteristics as well as event cluster characteristics, determining that the query does not have timeliness-oriented demands.

Furthermore, the judging whether the query belongs to the title characteristics or event cluster characteristics comprises:

judging whether, among the title characteristics, there exists a title characteristic whose similarity with the query is larger than a preset similarity threshold;

if the judgment result indicate the existence, determining that the query belongs to the title characteristics;

if the judgment result indicates absence, according to the query and the event cluster characteristic, obtaining an event cluster probability corresponding to the query, and judging whether the event cluster probability is larger than a preset probability threshold;
if the judgment result is yes, determining that the query belongs to the event cluster characteristics;

if the judgment result is no, determining that the query does not belong to the title characteristics as well as the event cluster characteristics.

It needs to be appreciated that the similarity larger than a preset similarity threshold includes the same situation, wherein a similarity algorithm may employ but is not limited to: editing distance, Jaccard similarity coefficient, cosine angle and the like.

Furthermore, as known from the above implementation mode of extracting the expression characteristics, the above event cluster characteristics comprise core words and co-occurring words of the core words of the event cluster corresponding to the event cluster characteristics. Based on this, the implementation mode of obtaining an event cluster probability corresponding to the query according to the query and the event cluster characteristic includes:

performing word segmentation processing for the query to obtain segmented words in the query; performing optional processing such as marking part of speech, identifying entity type and the like during word segmentation;

obtaining an event cluster characteristic whose core words belong to the segmented words in the query as an event cluster characteristic to be used; namely, determining whether the query might belong to a certain one or more event clusters by judging whether segmented words in the user-input query include the core words in the event cluster characteristic; if the judgment result is yes, this means that the query might be input into the event cluster corresponding to the event cluster characteristic (namely, the event cluster characteristic to be used) whose core words are included in the segmented words of the query; if the judgment result is no, the query does not belong to the event cluster;

performing weighting processing for importance degrees of segmented words in the query and weights of the segmented words in the query matched with the event cluster characteristic to be used, to obtain a probability that the query belongs to the event cluster characteristic to be used, wherein the larger the probability is, the larger the probability that the query belongs to the event cluster characteristic is, the larger the probability with timeliness-oriented demands is; the importance degrees of segmented words in the query may be understood as a proportion of the segmented words in all information of the query;

obtaining a maximum probability in probabilities that the query belongs to the event cluster characteristic as an event cluster probability corresponding to the query. If there exist a plurality of event cluster characteristics to be used, a maximum probability is selected therefrom as the event cluster probability of the query.

Furthermore, if the timeliness-oriented demands cannot be identified by using the method of identifying timeliness-oriented demands according to the present embodiment, further identification will be performed by employing other manners existing in the prior art, for example, based on the user's search behavior data as the posteriori knowledge.

It is appreciated that the method of identifying timeliness-oriented demands according to the present embodiment may be applied to various searching scenarios, for example, picture searching occasions, or text searching occasions. According to the difference of the searching scenarios, forms for implementing the user's input of the query vary. Therefore, the present embodiment does not limit the forms of the user-input query, and the query may be at least one of text, audio, video, picture and the like or combinations thereof.

To sum up, in the present embodiment whether the user-input query has timeliness-oriented demands is judged based on the pre-extracted expression characteristics capable of reflecting timeliness-oriented demands. The expression characteristics which are pre-extracted from the timeliness-oriented event reported by the timeliness-oriented site and are capable of reflecting timeliness-oriented demands belong to priori knowledge. The present embodiment sufficiently uses the priori knowledge for timeliness-oriented demands identification, does not rely on the posteriori knowledge such as the user's searching behavior data using the query, facilitates identifying the timeliness-oriented demands in a more timely manner, and improves the efficiency of identifying the timeliness-oriented demands.

As appreciated, for ease of description, the aforesaid method embodiments are all described as a combination of a series of actions, but those skilled in the art should appreciate that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 4 is a block diagram of an apparatus for identifying timeliness-oriented demands according to an embodiment of the present disclosure. As shown in FIG. 4, the apparatus comprises a receiving module 41 and an identifying module 42.

The receiving module 41 is configured to receive a query input by the user.

The identifying module 42 is configured to identify whether the query received by the receiving module 41 has timeliness-oriented demands based on expression characteristics which are pre-extracted from the timeliness-oriented event reported by the timeliness-oriented site and are capable of reflecting timeliness-oriented demands.

In an optional implementation mode, the expression characteristics include: title characteristics extracted from the timeliness-oriented event and event cluster characteristics extracted from the event cluster formed by the timeliness-oriented event. The identifying module 42 is specifically configured to:

judge whether the query belongs to the title characteristics or event cluster characteristics;

if the judgment result shows that the query belongs to the title characteristics or event cluster characteristics, determine that the query has timeliness-oriented demands;

if the judgment result shows that the query does not belong to the title characteristics as well as event cluster characteristics, determine that the query does not have timeliness-oriented demands.

Furthermore, upon judging whether the query belongs to the title characteristics or event cluster characteristics, the identifying module 42 is specifically configured to:

judge whether, among the title characteristics, there exists a title characteristic whose similarity with the query is larger than a preset similarity threshold;

if the judgment result indicate the existence, determine that the query belongs to the title characteristics;

if the judgment result indicates absence, according to the query and the event cluster characteristic, obtain an event cluster probability corresponding to the query, and judge whether the event cluster probability is larger than a preset probability threshold;

if the judgment result is yes, determine that the query belongs to the event cluster characteristics;

if the judgment result is no, determine that the query does not belong to the title characteristics as well as the event cluster characteristics.

Furthermore, the above event cluster characteristics comprise core words and co-occurring words of the core words of the event cluster corresponding to the event cluster characteristics. Based on this, upon obtaining an event cluster probability corresponding to the query according to the query and the event cluster characteristic, the identifying module 42 is specifically configured to:

performing word segmentation processing for the query to obtain segmented words in the query;

obtaining an event cluster characteristic whose core words belong to the segmented words in the query as an event cluster characteristic to be used;

performing weighting processing for importance degrees of segmented words in the query and weights of the segmented words in the query matched with the event cluster characteristic to be used, to obtain a probability that the query belongs to the event cluster characteristic to be used;

obtaining a maximum probability in probabilities that the query belongs to the event cluster characteristic as an event cluster probability corresponding to the query.

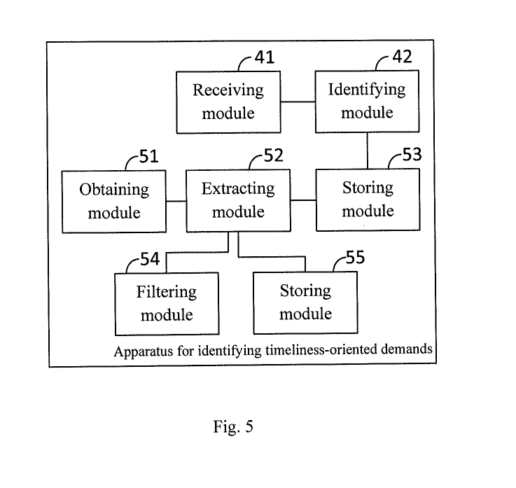

Furthermore, as shown in FIG. 5, the apparatus further comprises: an obtaining module 51, an extracting module 52 and a storing module 53.

The obtaining module 51 is configured to obtain a timeliness-oriented site before the identifying module 42 uses the expression characteristics to perform timeliness-oriented demand identification for the user-input query;

the extracting module 52 is configured to extract expression characteristics capable of reflecting timeliness-oriented demands from the timeliness-oriented event reported by the timeliness-oriented site obtained by the obtaining module 51;

the storing module 53 is configured to store the expression characteristics extracted by the extracting module 52.

In an optional implementation mode, the obtaining module 51 is specifically configured to:

obtain sites having reported a new timeliness-oriented event within a designated time period before the current time as initial sites, the designated time period referring to a time period at a designated time interval from the current time;

perform statistics of at least one of a click presentation rate, a reference rate and reporting timeliness of the initial sites;

according to at least one of the click presentation rate, the reference rate and the reporting timeliness of the initial sites, select from the initial sites a site as the timeliness-orientated site until a coverage rate of the timeliness-orientated site for the timeliness-oriented event is within a preset coverage rate range.

The designated time period in the designated time period before the current time may be half a year, one month or two weeks, and the designated time period before the current time may be half a year before the current time, a month before the current time or two weeks before the current time, or the like. That is to say, before the timeliness-oriented site is obtained, sites having reported a new timeliness-oriented event within half a year, one month or two weeks before the current time are first obtained as the initial sites.

The click presentation rate of the initial site may be obtained from the click presentation rate of the timeliness-oriented event reported by the initial site. The click presentation rate of the timeliness-oriented event reported by the initial site refers to a result obtained by weighting and averaging click times and presentation times of the timeliness-oriented event reported by the initial site.

The reference rate of the initial site may be obtained from a reference rate of the timeliness-oriented event reported by the initial site. The reference rate of the timeliness-oriented event reported by the initial site refers to a ratio of times of the timeliness-oriented event on the initial site being cited or transferred by other sites to total times of the timeliness-oriented event being cited or transferred by other sites.

The reporting timeliness of the initial site may be reflected by an average time interval between time when the initial site reports the timeliness-oriented event and time of occurrence of the timeliness-oriented event. The shorter the average time interval is, the more timely the event is reported, and the stronger the timeliness of the site is; the longer the average time interval is, the less timely the event is reported, and the less the timeliness of the site is. For example, the average time interval between time when the initial site reports the timeliness-oriented event and time of occurrence of the timeliness-oriented event may be obtained in the following manner: selecting several historical timeliness-oriented events, performing statistics of the time interval between time when the initial site reports each historical timeliness-oriented event and time of occurrence of each historical timeliness-oriented event, and obtaining an average value from the several time intervals.

Furthermore, upon selecting from the initial sites a site as the timeliness-orientated site according to at least one of the click presentation rate, the reference rate and the reporting timeliness of the initial sites, until a coverage rate of the timeliness-orientated site for the timeliness-oriented event is within a preset coverage rate range, the obtaining module 51 is specifically configured to:

according to at least one of the click presentation rate, the reference rate and the reporting timeliness of the initial sites, select from the initial sites a site in which at least one of the click presentation rate, the reference rate and the reporting timeliness satisfies the selection threshold as the timeliness-oriented site; calculate the coverage rate of the timeliness-oriented site for the timeliness-oriented event, and end the operation if the calculated coverage rate is within the preset coverage rate range; if the coverage rate is not within the coverage rate range, adjust the above selection threshold, and continue to, according to at least one of the click presentation rate, the reference rate and the reporting timeliness of the initial sites, select from the initial sites a site in which at least one of the click presentation rate, the reference rate and the reporting timeliness satisfies the adjusted selection threshold as the timeliness-oriented site, until the coverage rate of the timeliness-oriented site for the timeliness-oriented event is within the preset coverage rate range.

In an optional implementation mode, the extracting module 52 is specifically configured to:

extract, from the title of the timeliness-oriented event, title characteristics capable of reflecting timeliness-oriented demands;

perform timeliness-oriented demand mining for the event cluster formed by the timeliness-oriented event to obtain event cluster characteristics capable of reflecting the timeliness-oriented demands.

Furthermore, upon extracting, from the title of the timeliness-oriented event, title characteristics capable of reflecting timeliness-oriented demands, the extracting module 52 is specifically configured to:

consider a title of each timelines-oriented event as input;

set an initial weight of the title;

perform processing such as segmenting the title into words, marking part of speech of the words, identifying entity types and removing stop words therefrom, to obtain the title characteristics;

perform statistics of frequency of segmented words in the title characteristics;

if the frequency of segmented words belonging to a preset word class and a preset entity class in the title characteristic is lower than a certain threshold, adjust the weight of the title characteristic lower, and keep the weights of remaining title characteristics unchanged;

obtain the title characteristics and the weights of the title characteristics through the above processing;

store the above title characteristics and the weights of the title characteristics.

Furthermore, upon performing timeliness-oriented demand mining for the event cluster formed by the timeliness-oriented event to obtain event cluster characteristics capable of reflecting the timeliness-oriented demands, the extracting module 52 is specifically configured to:

perform word segmentation for the timeliness-oriented event to obtain segmented words in the timeliness-oriented event;

cluster the timeliness-oriented event according to the segmented words in the timeliness-oriented event to obtain at least one event cluster;

as for each event cluster in at least one event cluster, perform statistics of a frequency of segmented words and a file frequency in the event cluster;

according to the frequency of segmented words and the file frequency in the event cluster, select, from the segmented words in the event cluster, core words and co-occurring words of core words in the event cluster to constitute the event cluster characteristics corresponding to the event cluster.

Upon clustering the timeliness-oriented event according to the segmented words in the timeliness-oriented event to obtain at least one event cluster, the extracting module 52 is specifically configured to:

cluster the timeliness-oriented event by using a method such as KNN clustering or hierarchical clustering; or perform statistics of the frequency of high-frequency segmented words and file frequency in the timeliness-oriented event, filter stop words, then select a segmented word whose frequency and file frequency is larger than a certain threshold as a seed word of the cluster, and cluster timeliness-oriented events including the same seed word into one class, namely, an event cluster.

In an optional implementation mode, as shown in FIG. 5, the apparatus further comprises: a filtering module 54.

The filtering module 54 is configured to perform at least one of the following filtering processing:

removing low-quality sites may from the initial sites, the low-quality sites referring to sites whose quality is lower than a quality threshold;

relying on a preset non-timeliness-oriented dictionary to identify expression characteristics incapable of reflecting the timeliness-oriented demands among the expression characteristics, to remove expression characteristics incapable of reflecting the timeliness-oriented demands among the expression characteristics;

relying on a historical event without timeliness-oriented demands to identify expression characteristics incapable of reflecting the timeliness-oriented demands among the expression characteristics, to remove expression characteristics incapable of reflecting the timeliness-oriented demands among the expression characteristics. Specifically, the procedure of identifying expression characteristics incapable of reflecting the timeliness-oriented demands based on the historical event without timeliness-oriented demands may be: performing statistics of the number of matched results of the expression characteristics in the historical event and in the above timeliness-oriented event and calculating an entropy value; if the entropy value is larger than a certain threshold, this indicates that the expression characteristic cannot well distinguish the historical event without timeliness-oriented event from the timeliness-oriented event, and indicates that it has a poor capability of reflecting the timeliness-oriented demands. Hence, it is considered as the expression characteristics incapable of reflecting the timeliness-oriented demands and needs to be filtered away.

In an optional implementation mode, as shown in FIG. 5, the apparatus further comprises: a complementing module 55.

The complementing module 55 is configured to complement the expression characteristics according to the user's historical search behavior data.

For example, the complementing module 55 may combine the user's historical search behavior data with the timeliness-oriented event reported by the timeliness-oriented site to obtain input data so that the extracting module 52 extracts richer expression characteristics therefrom. Or, the complementing module 55 may also extract the expression characteristic only according to the user's historical search behavior data, and add the extracted expression characteristics into the expression characteristics extracted based on the timeliness-oriented event reported by the timeliness-oriented site, thereby forming richer expression characteristic. The user's historical search behavior data here refer to the user's behavior data of using the query to search during the historical search, and mainly refers to frequency change information that the searching frequency of the query suddenly increases at a certain time point or increases constantly in a certain time period.

The apparatus of identifying timeliness-oriented demands according to the present embodiment pre-extracts expression characteristics capable of reflecting timeliness-oriented demands from the timeliness-oriented event reported by the timeliness-oriented site, and judges whether the user-input query has timeliness-oriented demands based on the pre-extracted expression characteristics capable of reflecting timeliness-oriented demands. The expression characteristics which are pre-extracted from the timeliness-oriented event reported by the timeliness-oriented site and are capable of reflecting timeliness-oriented demands belong to priori knowledge. The apparatus of identifying timeliness-oriented demands according to the present embodiment sufficiently uses the priori knowledge for timeliness-oriented demands identification, does not rely on the posteriori knowledge such as the user's searching behavior data using the query, facilitates identifying the timeliness-oriented demands in a more timely manner, and improves the efficiency of identifying the timeliness-oriented demands.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

What is claimed is:

1. A method for identifying timeliness-oriented demands, comprising:
receiving a query input by the user;
identifying whether the query has timeliness-oriented demands based on expression characteristics which are pre-extracted from a timeliness-oriented event reported by a timeliness-oriented site and are capable of reflecting timeliness-oriented demands.

2. The method according to claim 1, wherein the expression characteristics include: title characteristics extracted from the timeliness-oriented event and event cluster characteristics extracted from the event cluster formed by the timeliness-oriented event;
the identifying whether the query has timeliness-oriented demands based on expression characteristics which are pre-extracted from a timeliness-oriented event reported by a timeliness-oriented site and are capable of reflecting timeliness-oriented demands comprises:
judging whether the query belongs to the title characteristics or event cluster characteristics;
if the judgment result shows that the query belongs to the title characteristics or event cluster characteristics, determining that the query has timeliness-oriented demands;
if the judgment result shows that the query does not belong to the title characteristics as well as event cluster characteristics, determining that the query does not have timeliness-oriented demands.

3. The method according to claim 2, wherein the judging whether the query belongs to the title characteristics or event cluster characteristics comprises:
judging whether, among the title characteristics, there exists a title characteristic whose similarity with the query is larger than a preset similarity threshold;
if the judgment result indicates the existence, determining that the query belongs to the title characteristics;
if the judgment result indicates the absence, according to the query and the event cluster characteristic, obtaining an event cluster probability corresponding to the query, and judging whether the event cluster probability is larger than a preset probability threshold;
if the judgment result is yes, determining that the query belongs to the event cluster characteristics;
if the judgment result is no, determining that the query does not belong to the title characteristics as well as the event cluster characteristics.

4. The method according to claim 3, wherein the event cluster characteristics comprise core words of the event cluster corresponding to the event cluster characteristics and co-occurring words of the core words;
the obtaining an event cluster probability corresponding to the query according to the query and the event cluster characteristic comprises:
performing word segmentation processing for the query to obtain segmented words in the query;
obtaining an event cluster characteristic whose core words belong to the segmented words in the query as an event cluster characteristic to be used;
performing weighting processing for importance degrees of segmented words in the query and weights of the segmented words in the query matched with the event cluster characteristic to be used, to obtain a probability that the query belongs to the event cluster characteristic to be used;
obtaining a maximum probability in probabilities that the query belongs to the event cluster characteristic as an event cluster probability corresponding to the query.

5. The method according to claim 1, wherein before identifying whether the query has timeliness-oriented demands based on expression characteristics which are pre-extracted from a timeliness-oriented event reported by a timeliness-oriented site and are capable of reflecting timeliness-oriented demands, the method comprises:
obtaining a timeliness-oriented site;
extracting expression characteristics capable of reflecting timeliness-oriented demands from the timeliness-oriented event reported by the timeliness-oriented site;
storing the expression characteristics.

6. The method according to claim 5, wherein the obtaining a timeliness-oriented site comprises:
obtaining sites having reported a new timeliness-oriented event within a designated time period before the current time as initial sites, the designated time period referring to a time period at a designated time interval from the current time;
performing statistics of at least one of a click presentation rate, a reference rate and reporting timeliness of the initial sites;
according to at least one of the click presentation rate, the reference rate and the reporting timeliness of the initial sites, selecting from the initial sites a site as the timeliness-orientated site until a coverage rate of the timeliness-orientated site for the timeliness-oriented event is within a preset coverage rate range.

7. The method according to claim 6, wherein the extracting expression characteristics capable of reflecting timeliness-oriented demands from the timeliness-oriented event reported by the timeliness-oriented site comprises:
extracting, from the title of the timeliness-oriented event, title characteristics capable of reflecting timeliness-oriented demands;
performing timeliness-oriented demand mining for the event cluster formed by the timeliness-oriented event to obtain event cluster characteristics capable of reflecting the timeliness-oriented demands.

8. The method according to claim 7, wherein the performing timeliness-oriented demand mining for the event cluster formed by the timeliness-oriented event to obtain event cluster characteristics capable of reflecting the timeliness-oriented demands comprises:
performing word segmentation for the timeliness-oriented event to obtain segmented words in the timeliness-oriented event;
clustering the timeliness-oriented event according to the segmented words in the timeliness-oriented event to obtain at least one event cluster;
as for each event cluster in at least one event cluster, performing statistics of a frequency of segmented words and a file frequency in the event cluster;
according to the frequency of segmented words and the file frequency in the event cluster, selecting, from the segmented words in the event cluster, core words of the event cluster and co-occurring words of core words to constitute the event cluster characteristics corresponding to the event cluster.

9-20. (canceled)

21. An apparatus, comprising
one or more processors;
a memory;
one or more programs stored in the memory and configured to perform the following operation when executed by the one or more processors:
receiving a query input by the user;
identifying whether the query has timeliness-oriented demands based on expression characteristics which are pre-extracted from a timeliness-oriented event reported by a timeliness-oriented site and are capable of reflecting timeliness-oriented demands.

22. (canceled)

23. The apparatus according to claim 9, wherein the expression characteristics include: title characteristics extracted from the timeliness-oriented event and event cluster characteristics extracted from the event cluster formed by the timeliness-oriented event;
the operation of identifying whether the query has timeliness-oriented demands based on expression characteristics which are pre-extracted from a timeliness-oriented event reported by a timeliness-oriented site and are capable of reflecting timeliness-oriented demands comprises:
judging whether the query belongs to the title characteristics or event cluster characteristics;
if the judgment result shows that the query belongs to the title characteristics or event cluster characteristics, determining that the query has timeliness-oriented demands;
if the judgment result shows that the query does not belong to the title characteristics as well as event cluster characteristics, determining that the query does not have timeliness-oriented demands.

24. The apparatus according to claim 10, wherein the operation of judging whether the query belongs to the title characteristics or event cluster characteristics comprises:
judging whether, among the title characteristics, there exists a title characteristic whose similarity with the query is larger than a preset similarity threshold;
if the judgment result indicates the existence, determining that the query belongs to the title characteristics;
if the judgment result indicates the absence, according to the query and the event cluster characteristic, obtaining an event cluster probability corresponding to the query, and judging whether the event cluster probability is larger than a preset probability threshold;
if the judgment result is yes, determining that the query belongs to the event cluster characteristics;
if the judgment result is no, determining that the query does not belong to the title characteristics as well as the event cluster characteristics.

25. The apparatus according to claim 11, wherein the event cluster characteristics comprise core words of the event cluster corresponding to the event cluster characteristics and co-occurring words of the core words;
the operation of obtaining an event cluster probability corresponding to the query according to the query and the event cluster characteristic comprises:
performing word segmentation processing for the query to obtain segmented words in the query;
obtaining an event cluster characteristic whose core words belong to the segmented words in the query as an event cluster characteristic to be used;
performing weighting processing for importance degrees of segmented words in the query and weights of the segmented words in the query matched with the event cluster characteristic to be used, to obtain a probability that the query belongs to the event cluster characteristic to be used;
obtaining a maximum probability in probabilities that the query belongs to the event cluster characteristic as an event cluster probability corresponding to the query.

25. The apparatus according to claim 9, wherein before identifying whether the query has timeliness-oriented demands based on expression characteristics which are pre-extracted from a timeliness-oriented event reported by a timeliness-oriented site and are capable of reflecting timeliness-oriented demands, the operation comprises:
obtaining a timeliness-oriented site;
extracting expression characteristics capable of reflecting timeliness-oriented demands from the timeliness-oriented event reported by the timeliness-oriented site;
storing the expression characteristics.

26. The apparatus according to claim 13, wherein the operation of obtaining a timeliness-oriented site comprises:
obtaining sites having reported a new timeliness-oriented event within a designated time period before the current time as initial sites, the designated time period referring to a time period at a designated time interval from the current time;
performing statistics of at least one of a click presentation rate, a reference rate and reporting timeliness of the initial sites;
according to at least one of the click presentation rate, the reference rate and the reporting timeliness of the initial sites, selecting from the initial sites a site as the timeliness-orientated site until a coverage rate of the timeliness-orientated site for the timeliness-oriented event is within a preset coverage rate range.

27. The apparatus according to claim 14, wherein the operation of extracting expression characteristics capable of reflecting timeliness-oriented demands from the timeliness-oriented event reported by the timeliness-oriented site comprises:
extracting, from the title of the timeliness-oriented event, title characteristics capable of reflecting timeliness-oriented demands:
performing timeliness-oriented demand mining for the event cluster formed by the timeliness-oriented event to obtain event cluster characteristics capable of reflecting the timeliness-oriented demands.

28. The apparatus according to claim 15, wherein the operation of performing timeliness-oriented demand mining for the event cluster formed by the timeliness-oriented event to obtain event cluster characteristics capable of reflecting the timeliness-oriented demands comprises:
performing word segmentation for the timeliness-oriented event to obtain segmented words in the timeliness-oriented event;
clustering the timeliness-oriented event according to the segmented words in the timeliness-oriented event to obtain at least one event cluster;
as for each event cluster in at least one event cluster, performing statistics of a frequency of segmented words and a file frequency in the event cluster;
according to the frequency of segmented words and the file frequency in the event cluster, selecting, from the segmented words in the event cluster, core words of the event cluster and co-occurring words of core words to constitute the event cluster characteristics corresponding to the event cluster.

29. A non-volatile computer storage medium in which one or more programs are stored, an apparatus being enabled to execute the following operation when said one or more programs are executed by the apparatus:
receiving a query input by the user;
identifying whether the query has timeliness-oriented demands based on expression characteristics which are pre-extracted from a timeliness-oriented event reported by a timeliness-oriented site and are capable of reflecting timeliness-oriented demands.

30. The non-volatile computer storage medium according to claim 17, wherein the expression characteristics include: title characteristics extracted from the timeliness-oriented event and event cluster characteristics extracted from the event cluster formed by the timeliness-oriented event;
the operation of identifying whether the query has timeliness-oriented demands based on expression characteristics which are pre-extracted from a timeliness-oriented event reported by a timeliness-oriented site and are capable of reflecting timeliness-oriented demands comprises:
judging whether the query belongs to the title characteristics or event cluster characteristics;
if the judgment result shows that the query belongs to the title characteristics or event cluster characteristics, determining that the query has timeliness-oriented demands;
if the judgment result shows that the query does not belong to the title characteristics as well as event cluster characteristics, determining that the query does not have timeliness-oriented demands.

31. The non-volatile computer storage medium according to claim 18, wherein the operation of judging whether the query belongs to the title characteristics or event cluster characteristics comprises:
judging whether, among the title characteristics, there exists a title characteristic whose similarity with the query is larger than a preset similarity threshold;
if the judgment result indicates the existence, determining that the query belongs to the title characteristics;
if the judgment result indicates the absence, according to the query and the event cluster characteristic, obtaining an event cluster probability corresponding to the query, and judging whether the event cluster probability is larger than a preset probability threshold;
if the judgment result is yes, determining that the query belongs to the event cluster characteristics;
if the judgment result is no, determining that the query does not belong to the title characteristics as well as the event cluster characteristics.

32. The non-volatile computer storage medium according to claim 19, wherein the event cluster characteristics comprise core words of the event cluster corresponding to the event cluster characteristics and co-occurring words of the core words:
the operation of obtaining an event cluster probability corresponding to the query according to the query and the event cluster characteristic comprises:
performing word segmentation processing for the query to obtain segmented words in the query:
obtaining an event cluster characteristic whose core words belong to the segmented words in the query as an event cluster characteristic to be used;
performing weighting processing for importance degrees of segmented words in the query and weights of the segmented words in the query matched with the event cluster characteristic to be used, to obtain a probability that the query belongs to the event cluster characteristic to be used;
obtaining a maximum probability in probabilities that the query belongs to the event cluster characteristic as an event cluster probability corresponding to the query.

33. The non-volatile computer storage medium according to claim 17, wherein before identifying whether the query has timeliness-oriented demands based on expression characteristics which are pre-extracted from a timeliness-oriented event reported by a timeliness-oriented site and are capable of reflecting timeliness-oriented demands, the operation comprises:
obtaining a timeliness-oriented site;
extracting expression characteristics capable of reflecting timeliness-oriented demands from the timeliness-oriented event reported by the timeliness-oriented site;
storing the expression characteristics.

34. The non-volatile computer storage medium according to claim 21, wherein the operation of obtaining a timeliness-oriented site comprises:
obtaining sites having reported a new timeliness-oriented event within a designated time period before the current time as initial sites, the designated time period referring to a time period at a designated time interval from the current time;
performing statistics of at least one of a click presentation rate, a reference rate and reporting timeliness of the initial sites;
according to at least one of the click presentation rate, the reference rate and the reporting timeliness of the initial sites, selecting from the initial sites a site as the timeliness-orientated site until a coverage rate of the timeliness-orientated site for the timeliness-oriented event is within a preset coverage rate range.

35. The non-volatile computer storage medium according to claim 22, wherein the operation of extracting expression characteristics capable of reflecting timeliness-oriented demands from the timeliness-oriented event reported by the timeliness-oriented site comprises:
extracting, from the title of the timeliness-oriented event, title characteristics capable of reflecting timeliness-oriented demands;
performing timeliness-oriented demand mining for the event cluster formed by the timeliness-oriented event to obtain event cluster characteristics capable of reflecting the timeliness-oriented demands.

36. The non-volatile computer storage medium according to claim 23, wherein the operation of performing timeliness-oriented demand mining for the event cluster formed by the timeliness-oriented event to obtain event cluster characteristics capable of reflecting the timeliness-oriented demands comprises:
performing word segmentation for the timeliness-oriented event to obtain segmented words in the timeliness-oriented event;
clustering the timeliness-oriented event according to the segmented words in the timeliness-oriented event to obtain at least one event cluster;
as for each event cluster in at least one event cluster, performing statistics of a frequency of segmented words and a file frequency in the event cluster;
according to the frequency of segmented words and the file frequency in the event cluster, selecting, from the segmented words in the event cluster, core words of the event cluster and co-occurring words of core words to constitute the event cluster characteristics corresponding to the event cluster.
